(19) United States
(12) Patent Application Publication
(10) Pub. No.: US 2016/0298006 A1
(43) Pub. Date: Oct. 13, 2016

(54) OPTICAL ADHESIVE COMPOSITION, OPTICAL ADHESIVE FILM AND OPTICAL LAMINATE

(71) Applicants: Kuo-Teng Hsu, Hsinchu (TW); Chih-Tsung Lu, Hsinchu (TW); Tse-Hung Hsiao, Hsinchu (TW); Yi-Chang Lin, Hsinchu (TW); Chia-Feng Chen, Hsinchu (TW); Lie-Zen Chung, Hsinchu (TW)

(72) Inventors: Kuo-Teng Hsu, Hsinchu (TW); Chih-Tsung Lu, Hsinchu (TW); Tse-Hung Hsiao, Hsinchu (TW); Yi-Chang Lin, Hsinchu (TW); Chia-Feng Chen, Hsinchu (TW); Lie-Zen Chung, Hsinchu (TW)

(73) Assignee: KOATECH TECHNOLOGY CORPORATION, Hsinchu Hsien (TW)

(21) Appl. No.: 14/729,071

(22) Filed: Jun. 3, 2015

(30) Foreign Application Priority Data
Apr. 10, 2015 (TW) 104111599

(51) Int. Cl. C09J 133/08; C09J 133/14; C08J 3/28

(52) U.S. Cl. CPC C09J 133/08; C08J 3/28; C09J 133/14; C08J 2333/08; C08J 2333/14

(57) ABSTRACT

An optical adhesive composition is provided. The optical adhesive composition includes an acrylic-based polymer having at least one group selected from hydroxyl, amino and carboxylic acid group, a crosslinking agent having isocyanate groups, a acrylic-based oligomer having at least one unsaturated group and a photo initiator, wherein based on 100 parts by weight of the acrylic-based polymer, the content of the acrylic-based oligomer is 1 part by weight to 7 parts by weight.

### CROSS-REFERENCE TO RELATED APPLICATION

This application claims the priority benefit of Taiwan application serial no. 104111599, filed on Apr. 10, 2015. The entirety of the above-mentioned patent application is hereby incorporated by reference herein and made a part of this specification.

### BACKGROUND OF THE INVENTION

1. Field of the Invention

The invention relates to an optical adhesive composition, an optical adhesive film and an optical laminate, and particularly relates to a photo-curable optical adhesive composition, an optical adhesive film made of the photo-curing optical adhesive composition and an optical laminate using the optical adhesive film.

2. Description of Related Art

Along with quick development of thin-film transistor displays, touch panel techniques are quickly developed, wherein a touch panel display includes a touch panel and a liquid crystal panel. In the present industry, transparent optical adhesive is generally used to adhere various film layers in the liquid crystal panel, and adhere the liquid crystal panel and the touch panel and adhere various film layers in the touch panel. However, when the conventional optical adhesive is used to implement laminate adhesion, bubbles are probably produced to cause a problem that the laminate is unable to be tightly adhered. This is because that the conventional optical adhesive cannot effectively fill a step gap on the laminate caused by setting a decoration film, a frame edge film, etc. at the edge of the laminate due to a design and application requirement. Therefore, how to fabricate an optical adhesive achieving a balance between an ink gap absorbency and a die-cutting property has become one of the most important problems to be resolved by related technicians.

### SUMMARY OF THE INVENTION

The invention is directed to an optical adhesive composition, which is used for fabricating an optical adhesive film that achieves a balance in an ink gap absorbency and a die-cutting property and is adapted to be applied in an optical laminate.

The invention provides an optical adhesive composition including an acrylic-based polymer, a crosslinking agent, an acrylic-based oligomer and a photo initiator. The acrylic-based polymer has at least one group selected from a hydroxyl group, an amino group and a carboxylic acid group. The crosslinking agent has isocyanate groups. The acrylic-based oligomer has at least one unsaturated group, wherein based on 100 parts by weight of the acrylic-based polymer, the content of the acrylic-based oligomer is 1 part by weight to 7 parts by weight.

In an embodiment of the invention, the average molecular weight of the acrylic-based polymer is 200000 to 1000000, and the molecular weight distribution (Mw/Mn) of the acrylic-based polymer is 4 to 12.

In an embodiment of the invention, relative to the weight of the acrylic-based polymer, the content of the hydroxyl group is 15 wt % to 40 wt %.

In an embodiment of the invention, the acrylic-based polymer includes at least one segment selected from segments represented by following formulas 1 and 2:

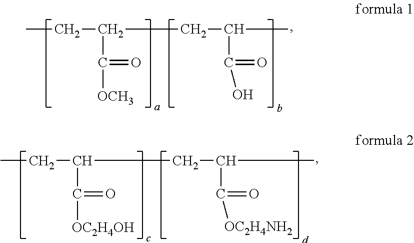

wherein a is 1 to 50000, b is 1 to 20000, c is 1 to 1000, and d is 1 to 1000.

In an embodiment of the invention, relative to the weight of the crosslinking agent, the content of the isocyanate group (-NCO) is 10 wt % to 20 wt %, and in each molecule of the crosslinking agent, the number of the isocyanate groups is three or more.

In an embodiment of the invention, the crosslinking agent includes a compound represented by following formula 3:

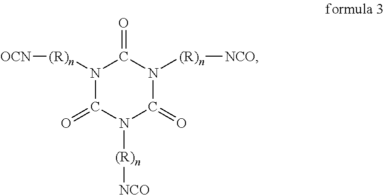

wherein R is an aromatic group or an aliphatic group, and n is 1 to 6.

In an embodiment of the invention, the acrylic-based oligomer includes mono-functional polyurethane having one acrylic group, multi-functional polyurethane having more than one acrylic group, or a combination thereof, where the average molecular weight of the acrylic-based oligomer is 1000 to 10000.

In an embodiment of the invention, the acrylic-based oligomer includes a compound represented by following formula 4:

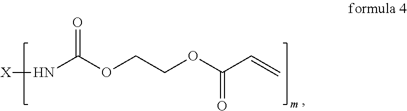

wherein X is an aromatic group or an aliphatic group, and 1≦m≦6.

In an embodiment of the invention, based on 100 parts by weight of the acrylic-based polymer, the content of the crosslinking agent is 0.05 part by weight to 0.07 part by weight, and the content of the photo initiator is 0.5 part by weight to 8 parts by weight.

The invention provides an optical adhesive film manufactured by performing a curing process to the aforementioned optical adhesive composition.

The invention provides an optical laminate including a first substrate, a second substrate and the aforementioned optical adhesive film, where the optical adhesive film is disposed between the first substrate and the second substrate.

According to the above descriptions, the optical adhesive composition of the invention includes the acrylic-based polymer, the crosslinking agent, the acrylic-based oligomer and the photo initiator, and the acrylic-based oligomer has a specific content, such that the optical adhesive film obtained after curing achieves a balance in an ink gap absorbency and a die-cutting property and has a good light transmittance.

In order to make the aforementioned and other features and advantages of the invention comprehensible, several exemplary embodiments accompanied with figures are described in detail below.

### BRIEF DESCRIPTION OF THE DRAWINGS

None

### DESCRIPTION OF EMBODIMENTS

In this context, a range represented by “one value to another value” is a schematic representation in order to avoid listing all of the values in such range in the disclosure. Therefore, description of a specific value range covers any value within such value range and a smaller value range defined by any value within such value range, which is the equivalent to write down the specific value and the smaller value range in the disclosure.

In the context, a skeleton formula is sometimes used to represent a structure of a polymer or a group. In such representation, carbon atoms, hydrogen atoms and carbon-hydrogen bonds can be omitted. Certainly, if the atoms or atom groups are definitely drawn in the structural formula, the drawn one shall prevail.

In order to fabricate an optical adhesive film that achieves a balance in an ink gap absorbency and a die-cutting property and is adapted to be applied in an optical laminate, the invention provides an optical adhesive composition to achieve the aforementioned advantages. Embodiments are provided below to describe the invention in detail.

An embodiment of the invention provides an optical adhesive composition including an acrylic-based polymer, a crosslinking agent, an acrylic-based oligomer and a photo initiator.

The acrylic-based polymer has at least one group selected from a hydroxyl group, an amino group and a carboxylic acid group. In detail, the average molecular weight of the acrylic-based polymer is 200000 to 1000000, and preferably 400000 to 800000, and the molecular weight distribution (Mw/Mn) of the acrylic-based polymer is 4 to 12, and preferably 4.5 to 11.5. Moreover, in case that the acrylic-based polymer has the hydroxyl group, relative to the weight of the acrylic-based polymer, the content of the hydroxyl group is 15 wt % to 40 wt %, and preferably 20 wt % to 35 wt %.

Moreover, the acrylic-based polymer takes acrylic-based monomers as polymerisation units. In the present embodiment, the acrylic-based monomer includes but is not limited to acrylic acid, methyl acrylate, methyl methacrylate, ethyl acrylate, ethyl methacrylate, aminoethyl acrylate, hydroxyethyl acrylate, etc. To be specific, in an embodiment, the acrylic-based polymer includes, for instance, at least one segment selected from segments represented by following formulas 1 and 2:

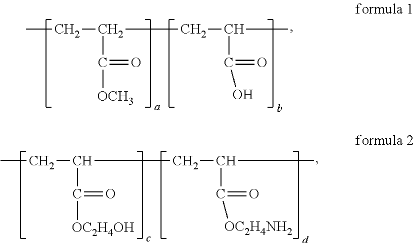

wherein a is 1 to 50000, b is 1 to 20000, c is 1 to 1000, and d is 1 to 1000.

In the present embodiment, the crosslinking agent has isocyanate groups, and relative to the weight of the crosslinking agent, the content of the isocyanate group (—NCO) is 10 wt % to 20 wt %, and preferably 8 wt % to 15 wt %. Moreover, in each molecule of the crosslinking agent, the number of the isocyanate groups is three or more.

To be specific, in an embodiment, the crosslinking agent includes, for instance, a compound represented by following formula 3:

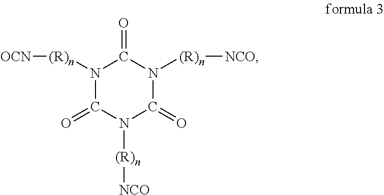

wherein R is an aromatic group or an aliphatic group, and n is 1 to 6.

Moreover, in the optical adhesive composition, the content of the crosslinking agent can be adjusted according to types of the used acrylic-based polymer and the used acrylic-based oligomer and the application of the optical adhesive composition. In an embodiment, based on 100 parts by weight of the acrylic-based polymer, the content of the crosslinking agent is 0.05 part by weight to 0.07 part by weight, and preferably 0.07 part by weight. Based on 100 parts by weight of the acrylic-based polymer, when the content of the crosslinking agent is too low, the optical adhesive film made of the optical adhesive composition (related description thereof is presented later) is liable to have a poor weather resistance and a poor processing property, and when the content of the crosslinking agent is too high, the optical adhesive film made of the optical adhesive composition probably have a poor flowing filling property.

The acrylic-based oligomer is a photocurable resin that may undergo a polymerisation reaction after being irradiated by ultraviolet (UV) light. In the present embodiment, the acrylic-based oligomer has at least one unsaturated group. In detail, the acrylic-based oligomer includes mono-functional polyurethane having one acrylic group, multi-functional polyurethane having more than one acrylic group, or a combination thereof, wherein the average molecular weight of the acrylic-based oligomer is 1000 or more, and preferably 1000 to 10000.

To be specific, in an embodiment, the acrylic-based oligomer includes, for instance, a compound represented by following formula 4:

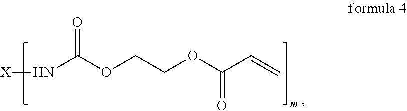

wherein X is an aromatic group or an aliphatic group, and 1≦m≦6. Moreover, the acrylic-based oligomer can be commercially available products, for example, CN962, CN929, CN983, CN972 (fabricated by SATOMER Co., Ltd.) or UN-350, UN-3320HA, UN-1255 (fabricated by Negami Kogyo Co., Ltd.).

Moreover, in the present embodiment, the optical adhesive composition may only include a single type of the acrylic-based oligomer or may include two or more types of the acrylic-based oligomers. In detail, when two or more types of the acrylic-based oligomers are used, the acrylic-based oligomers have different viscosities, glass transition temperatures, or molecular weights. For example, when two types of the acrylic-based oligomers are used, the acrylic-based oligomers can both be repressed by formula 4, though their groups represented by X and/or their values of m are different.

Moreover, based on 100 parts by weight of the acrylic-based polymer, the content of the acrylic-based oligomer is 1 part by weight to 7 parts by weight. In the present embodiment, by controlling the content of the acrylic-based oligomer to be within the aforementioned range, the ink gap absorbency and die-cutting property of the optical adhesive film made of the optical adhesive composition is further improved.

The photo initiator is used for absorbing the UV light and initiates a polymerisation reaction of the acrylic-based polymer and the acrylic-based oligomer for curing. In the present embodiment, the photo initiator includes but is not limited to benzophenone, hydroxycyclohexyl benzophenone, compounds having 2,4,6-trimethylbenzoyl group, benzoin ether, bezoin isopropyl ether, benzanthrone, etc.

The type and an adding level of the photo initiator can be determined according to the types of the used acrylic-based polymer and the used acrylic-based oligomer. For example, in an embodiment, based on 100 parts by weight of the acrylic-based polymer, the content of the photo initiator is 0.5 part by weight to 8 parts by weight, and preferably 1 part by weight to 7 parts by weight.

Moreover, in the present embodiment, the optical adhesive composition may also include a proper amount of solvent to adjust a solid content, so as to facilitate coating. The solvent can by any solvent known by those skilled in the art, and the solvent may include but is not limited to toluene, xylene, ethyl acetate, butanone, acetone, or a combination thereof.

It should be noticed that in the present embodiment, as the optical adhesive composition includes the components of the acrylic-based polymer, the crosslinking agent, the acrylic-based oligomer and the photo initiator, and the acrylic-based oligomer has a specific content, the suitable optical adhesive film achieving the balance in the ink gap absorbency and the die-cutting property can be fabricated without using reagents such as plasticizer, tackifier, etc.

Another embodiment of the invention provides an optical adhesive film, which is obtained by performing a curing process on any optical adhesive composition in the aforementioned embodiment. In detail, in an embodiment of the invention, the method for manufacturing the optical adhesive film includes heating and drying the aforementioned optical adhesive composition. In another embodiment, the method for manufacturing the optical adhesive film includes heating and drying the optical adhesive composition and then performing UV exposure treatment on the optical adhesive composition.

When the optical adhesive film has a good ink gap absorbency to avoid generating bubbles, since the optical adhesive film is relatively soft, it is not easy to be cut and processed so that problems of adhesive overflow and adhesive grabbing are caused, wherein the adhesive grabbing refers to that when an optical laminate including the optical adhesive film (which is described later) is cut and processed, since a part of the adhesive film is attached to outside of the substrates, when one of the substrates is peeled off, the adhesive film is brought together or the structure of the adhesive film is spoiled. Comparatively, when the optical adhesive film has a good die-cutting property to facilitate processing, since the optical adhesive film is relatively hard, it is not liable to fill the step gap so that bubbles are caused. Therefore, in the embodiment of the invention, as the optical adhesive composition includes the components of the acrylic-based polymer, the crosslinking agent, the acrylic-based oligomer and the photo initiator, and the acrylic-based oligomer has a specific content, the optical adhesive film may achieve the balance in the ink gap absorbency and the die-cutting property. Moreover, in the present embodiment, as the optical adhesive composition includes the components of the acrylic-based polymer, the crosslinking agent, the acrylic-based oligomer and the photo initiator, and the acrylic-based oligomer has the specific content, the optical adhesive film may have a good light transmittance (the light transmittance is greater than 99%). In this way, the optical adhesive film of the invention can reduce unnecessary loss caused by poor cutting processing in utilization, so as to improve a utilization ratio, and avoid generating bubbles when filling the step gap, so as to improve an overall production yield. Furthermore, the optical adhesive film of the invention is adapted to adhering processes of various optical displays, for example, adhering processes of a resistive touch panel display, a capacitive touch panel display, a 3D display, etc.

Another embodiment of the invention provides an optical laminate including a first substrate, a second substrate and any optical adhesive film of the aforementioned embodiment, wherein the optical adhesive film is disposed between the first substrate and the second substrate to adhere the first substrate and the second substrate. Types of the first substrate and the second substrate can be determined according to the application of the optical laminate. In detail, the optical laminate is, for example, an optical adhesive sheet, or a laminate in an optical display such as a resistive touch panel display, a capacitive touch panel display, a 3D display, etc. The type of each of the first substrate and the second substrate may independently includes optical glass, plastic board (for example, polycarbonate board, polyethylene terephthalate board), transparent conductive glass (for example, indium tin oxide (ITO) conductive glass), ITO-polyethylene terephthalate (PET) film, liquid crystal panel, touch panel, decoration film, outer protection film, release film (for example, PET release film), etc.

A method for manufacturing the optical laminate may include following steps. First, the aforementioned optical adhesive composition is coated on the first substrate, and a curing process is performed to form the optical adhesive film on the first substrate. Then, the second substrate is adhered to the optical adhesive film. The coating method includes, for example, knife coating, roller coating, micro gravure coating, flow coating, dip coating, spray coating, curtain coating or a combination thereof.

It should be noticed that the optical adhesive film of the invention achieves the balance in the ink gap absorbency and the die-cutting property and has a good light transmittance, such that when the optical laminate of the invention serves as a laminate in the optical display, the optical display may have a good production yield, reliability and optical property, and when the optical laminate of the invention serves as the optical adhesive sheet in an adhering process, a usage rate of the optical adhesive sheet is enhanced, and a yield of the adhering process is increased.

Examples 1-13 and Comparison example 1 are provided below to describe the features of the invention in detail. Although Examples 1-13 are described below, the used material, the material usage amount and ratio, processing detail and processing flow, etc. can be properly modified without departing from the spirit and scope of the invention. Therefore, the invention is not limited to the following provided embodiments.

### Example 1

In a lithography laboratory isolating the UV light, the acrylic-based polymer of 100 parts by weight, the crosslinking agent of 0.07 part by weight, the acrylic-based oligomer A of 1 part by weight, the photo initiator of 5 parts by weight were sequentially added, and were stirred by 30 minutes under 25° C., 400 rpm, so as to form the optical adhesive composition of Example 1.

Then, the optical adhesive composition was coated on a PET release film (Nan Ya plastics Corp. model No. L150A) through knife coating. Thereafter, the coated PET release film was put in an oven of 100° C. by 3 minutes to dry, so as to obtain the PET release film having the optical adhesive film with a dry film thickness of 175 μm thereon. Then, the PET release film was fetched out, and the optical adhesive film was covered by another release film (Nan Ya plastics Corp. model No. H8A0A) to form the optical laminate of Example 1.

### Example 2 to Example 4

The optical adhesive composition and the optical laminate of each of Examples 2-4 were manufactured according to the same manufacturing process of Example 1, and the difference therebetween is that adding amounts of the used components were different, and specific adding amounts are shown in a following table

### Example 5 to Example 6

The optical adhesive composition and the optical laminate of each of Examples 5-6 were manufactured according to the same manufacturing process of Example 1, and the difference therebetween is that the dry film thicknesses of the optical adhesive films were different, and specific thicknesses thereof are shown in the following table 1.

### Example 7

The optical adhesive composition and the optical laminate of Example 7 were manufactured according to the same manufacturing process of Example 1, and the difference therebetween is that the types and adding amounts of the used components were different, and specific types and the adding amounts thereof are shown in the following table 1.

### Example 8

The optical adhesive composition and the optical laminate of Example 8 were manufactured according to the same manufacturing process of Example 7, and the difference therebetween is that the adding amounts of the used components were different, and specific adding amounts thereof are shown in the following table 1.

### Example 9 to Example 10

The optical adhesive composition and the optical laminate of each of Examples 9-10 were manufactured according to the same manufacturing process of Example 8, and the difference therebetween is that the dry film thicknesses of the optical adhesive films were different, and specific thicknesses thereof re shown in the following table 1.

### Example 11

The optical adhesive composition and the optical laminate of Example 11 were manufactured according to the same manufacturing process of Example 7, and the difference therebetween is that the adding amounts of the used components were different, and specific adding amounts thereof are shown in the following table 1.

### Example 12 to Example 13

The optical adhesive composition and the optical laminate of each of Examples 12-13 were manufactured according to the same manufacturing process of Example 11, and the difference therebetween is that the dry film thicknesses of the optical adhesive films were different, and specific thicknesses thereof are shown in the following table 1.

### Comparison Example 1

The optical adhesive composition and the optical laminate of Comparison example 1 are manufactured according to a manufacturing process the same as that of Example 1, and the difference therebetween is that in Comparison example 1, none acrylic-based oligomer (i.e. acrylic-based oligomer A and acrylic-based oligomer B) was used.

Then, before a test for die-cutting and adhesive overflow, a test for release film pull off f and a step gap filling test were respectively performed to the optical laminates of Examples 1-13 and Comparison example 1, a light transmittance test was first performed to the optical laminates of Examples 1-13 and Comparison example 1, wherein the light transmittances of the optical laminates of Examples 1-13 are all greater than 99%. It should be noticed that if the light transmittance of the optical laminate is smaller than 99%, the test for die-cutting and adhesive overflow, the test for release film pull off and the step gap filling test are not performed. Moreover, descriptions of the test for die-cutting and adhesive overflow, the test for release film pull off and the step gap filling test are as follows, and test results thereof are shown in the following table 1.

### Test for Die-Cutting and Adhesive Overflow

First, a pair of scissors serving as a cutting tool was wiped by using alcohol. Then, the pair of scissors was used to respectively cut the optical laminates of Examples 1-13 and Comparison example 1. Thereafter, the cutting sides of the optical laminates of Examples 1-13 and Comparison example 1 were respectively dragged backwards along a plane with a tilting angle of 30 degrees, and it was observed through naked eyes to determine whether the optical adhesive film in the optical laminate is dragged out.

Evaluation criteria: the test results of the optical laminates of Examples 1-13 and Comparison example 1 were compared to evaluate levels of an adhesive overflow degree, wherein the levels are respectively 5-level, 4.5-level, 4-level, 3.5-level, 3-level, 2.5-level, 2-level, 1.5-level and 1-level, and the higher the level is, the lower the adhesive overflow degree is, and the better the die-cutting property thereof is.

### Test for Release Film Pull Off

First, a pair of scissors serving as a cutting tool was wiped by using alcohol. Then, the pair of scissors was used to respectively cut the optical laminates of Examples 1-13 and Comparison example 1. Thereafter, the release films were respectively peeled off from the cutting sides of the optical laminates of Examples 1-13 and Comparison example 1, and it was observed through naked eyes to determine whether the optical adhesive film in the optical laminate has the adhesive grabbing phenomenon.

Evaluation criteria: the test results of the optical laminates of Examples 1-13 and Comparison example 1 were compared to evaluate levels of an adhesive grabbing degree, wherein the levels are respectively 5-level, 4.5-level, 4-level, 3.5-level, 3-level, 2.5-level, 2-level, 1.5-level and 1-level, and the higher the level is, the lower the adhesive grabbing degree is, and the better the die-cutting property thereof is.

### Step Gap Filling Test

The test steps are described below with reference of the step gap filling test performed on the optical laminate of Example 1.

First, the optical laminate of Example 1 was adhered to optical glass in a soft to hard process. Then, the optical laminate of Example 1 that had been adhered to the optical glass was adhered to glass covered with ink of different thickness in a hard to hard process to obtain a plurality of test samples. Then, an autoclave treatment was performed to the test samples by 20 minutes under a temperature of 50° C. and a pressure of 0.5 Mpa. Thereafter, it was observed with naked eyes to determine whether bubbles are generated near the ink in each of the test samples, and the thickest ink thickness of the test sample without any bubble was recorded to evaluate the step gap filling capability.

In detail, the thickness value recorded in the table 1 is the thickest ink thickness of the test sample without any bubble, and the recorded value=(5×(the thickest thickness value/10))/7, and the higher the value is, the better the step gap filling capability is.

TABLE 1

| | | Example 1 | Example 2 | Example 3 | Example 4 | Example 5 | Example 6 | Example 7 |
|---|---|---|---|---|---|---|---|---|
| Acrylic-based polymer | | 100 | 100 | 100 | 100 | 100 | 100 | 100 |
| (parts by weight) | | | | | | | | |
| Crosslinking agent | | 0.07 | 0.07 | 0.07 | 0.05 | 0.07 | 0.07 | 0.07 |
| (parts by weight) | | | | | | | | |
| Acrylic-based | acrylic-based | 1 | 3 | 5 | 1 | 1 | 1 | 1.5 |
| oligomer | oligomer A | | | | | | | |
| | (parts by weight) | | | | | | | |
| | acrylic-based | — | — | — | — | — | — | 1.5 |
| | oligomer B | | | | | | | |
| | (parts by weight) | | | | | | | |

| Photo initiator (parts by weight) | 5 | | 5 | | 5 | | 5 | | 5 | | 5 | | 5 | |
|---|---|---|---|---|---|---|---|---|---|---|---|---|---|---|
| Dry film thickness (μm) | 175 | | 175 | | 175 | | 175 | | 200 | | 150 | | 175 | |
| Adhesive overflow degree | 4 | | 5 | | 5 | | 5 | | 4 | | 5 | | 4.5 | |
| Adhesive grabbing degree | 4 | | 5 | | 5 | | 5 | | 4 | | 5 | | 4.5 | |
| Step gap filling capability | 20 μm | 1.4 | 28 μm | 2.0 | 31 μm | 2.2 | 31 μm | 2.2 | 27 μm | 1.9 | 14 μm | 1 | 38 μm | 2.7 |

| | | | | | | | | Comparison |
|---|---|---|---|---|---|---|---|---|
| | | Example 8 | Example 9 | Example 10 | Example 11 | Example 12 | Example 13 | example 1 |
| Acrylic-based polymer | | 100 | 100 | 100 | 100 | 100 | 100 | 100 |
| (parts by weight) | | | | | | | | |
| Crosslinking agent | | 0.07 | 0.07 | 0.07 | 0.07 | 0.07 | 0.07 | 0.07 |
| (parts by weight) | | | | | | | | |
| Acrylic-based | acrylic-based | 3 | 3 | 3 | 3 | 3 | 3 | — |
| oligomer | oligomer A | | | | | | | |
| | (parts by weight) | | | | | | | |
| | acrylic-based | 2 | 2 | 2 | 4 | 4 | 4 | — |
| | oligomer B | | | | | | | |
| | (parts by weight) | | | | | | | |

| Photo initiator (parts by weight) | 5 | | 5 | | 5 | | 5 | | 5 | | 5 | | — | |
|---|---|---|---|---|---|---|---|---|---|---|---|---|---|---|
| Dry film thickness (μm) | 175 | | 150 | | 125 | | 175 | | 150 | | 125 | | 175 | |
| Adhesive overflow degree | 4 | | 4.5 | | 5 | | 1 | | 3 | | 5 | | 1 | |
| Adhesive grabbing degree | 4 | | 4.5 | | 5 | | 2 | | 3 | | 5 | | 1 | |
| Step gap filling capability | 62 μm | 4.6 | 26 μm | 1.9 | 14 μm | 1 | 70 μm | 5 | 32 μm | 2.3 | 21 μm | 1.5 | 15 μm | 1.1 |

According to the above table 1, it is known that compared to the optical laminate of Comparison example 1, the optical laminates of Examples 1-4, Examples 7-8, and Example 11 have good ink gap absorbency and die-cutting property, which represents that by controlling the optical adhesive composition to contain the acrylic-based oligomer with a specific content, the ink gap absorbency and the die-cutting property of the optical adhesive film can be simultaneously improved to achieve a balance therebetween. Further, compared to the optical laminates of Examples 1-4, Example 7 and Example 11, the optical laminate of Example 8 achieves a superior balance between the ink gap absorbency and the die-cutting property, which represents that by using different types of the acrylic-based oligomer in combination in the optical adhesive composition, and adjusting an addition proportion thereof, the optical adhesive film has better characteristics, so as to improve application flexibility of the optical adhesive composition.

Moreover, according to the adhesive overflow degrees and the adhesive grabbing degrees of the optical laminates of Examples 8-13, it is known that the thinner the thickness of the optical adhesive film is, the better the die-cutting property is.

In addition, according to the test results of the step gap filling test performed on the optical laminates of Example 1, Examples 5-6, and Examples 8-13, it is known that by improving the content of the acrylic-based oligomer B in the optical adhesive composition, the ink gap absorbency of the optical adhesive film is effectively improved. Therefore, the optical adhesive film may have a good ink gap absorbency in case of a thinner thickness, and when the optical adhesive film is applied to an optical display, the manufacturing cost and an overall thickness thereof can be decreased.

It will be apparent to those skilled in the art that various modifications and variations can be made to the structure of the invention without departing from the scope or spirit of the invention. In view of the foregoing, it is intended that the invention cover modifications and variations of this invention provided they fall within the scope of the following claims and their equivalents.

What is claimed is:

1. An optical adhesive composition, comprising:
an acrylic-based polymer, having at least one group selected from a hydroxyl group, an amino group and a carboxylic acid group;
a crosslinking agent, having isocyanate groups;
an acrylic-based oligomer, having at least one unsaturated group; and
a photo initiator, wherein based on 100 parts by weight of the acrylic-based polymer, a content of the acrylic-based oligomer is 1 part by weight to 7 parts by weight.

2. The optical adhesive composition as claimed in claim 1, wherein an average molecular weight of the acrylic-based polymer is 200000 to 1000000, and a molecular weight distribution (Mw/Mn) of the acrylic-based polymer is 4 to 12.

3. The optical adhesive composition as claimed in claim 1, wherein relative to a weight of the acrylic-based polymer, a content of the hydroxyl group is 15 wt % to 40 wt %.

4. The optical adhesive composition as claimed in claim 1, wherein the acrylic-based polymer comprises at least one segment selected from segments represented by formulas 1 and 2: 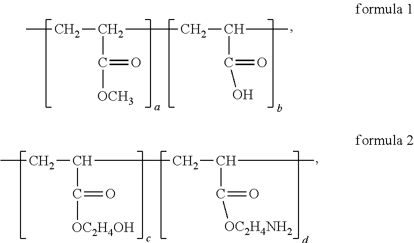
wherein a is 1 to 50000, b is 1 to 20000, c is 1 to 1000, and d is 1 to 1000.

5. The optical adhesive composition as claimed in claim 1, wherein relative to a weight of the crosslinking agent, a content of the isocyanate group (—NCO) is 10 wt % to 20 wt %, and in each molecule of the crosslinking agent, a number of the isocyanate groups is three or more.

6. The optical adhesive composition as claimed in claim 1, wherein the crosslinking agent comprises a compound represented by formula 3: 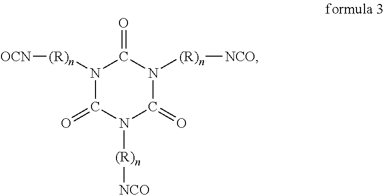
wherein R is an aromatic group or an aliphatic group, and n is 1 to 6.

7. The optical adhesive composition as claimed in claim 1, wherein the acrylic-based oligomer comprises mono-functional polyurethane having one acrylic group, multi-functional polyurethane having more than one acrylic group, or a combination thereof, wherein an average molecular weight of the acrylic-based oligomer is 1000 to 10000.

8. The optical adhesive composition as claimed in claim 7, wherein the acrylic-based oligomer comprises a compound represented by formula 4: 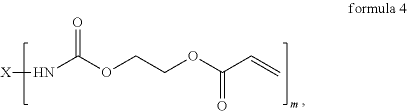
wherein X is an aromatic group or an aliphatic group, and 1≦m≦6.

9. The optical adhesive composition as claimed in claim 1, wherein based on 100 parts by weight of the acrylic-based polymer, a content of the crosslinking agent is 0.05 part by weight to 0.07 part by weight, and a content of the photo initiator is 0.5 part by weight to 8 parts by weight.

10. An optical adhesive film, manufactured by performing a curing process to the optical adhesive composition as claimed in claim 1.

11. An optical laminate, comprising:
a first substrate;
a second substrate; and
the optical adhesive film as claimed in claim 10, disposed between the first substrate and the second substrate.
